(19) United States
(12) Patent Application Publication
(10) Pub. No.: US 2008/0151176 A1
(43) Pub. Date: Jun. 26, 2008

(54) MULTIPURPOSE SPECTACLE CASE

(75) Inventor: Sik Lung Lam, Hong Kong (HK)

Correspondence Address: FAEGRE & BENSON LLP;PATENT DOCKETING, 2200 WELLS FARGO CENTER, 90 SOUTH SEVENTH STREET, MINNEAPOLIS, MN, 55402-3901, US

(73) Assignee: Okia Optical Co., Ltd., Kowloon (HK)

(21) Appl. No.: 12/021,401

(22) Filed: Jan. 29, 2008

Related U.S. Application Data
(62) Division of application No. 10/794,684, filed on Mar. 5, 2004.

(51) Int. Cl. G02C 9/00

(52) U.S. Cl. 351/47

(57) ABSTRACT

A spectacle case including a housing assembly, a spectacle compartment, and at least one accessory compartment assembly. The housing assembly defines a housing space for storing a pair of spectacles therein. The housing space comprises a spectacle space and a remaining dead space. The spectacle compartment occupies the spectacle space defining an area that is reserved for occupation of the spectacle when the spectacle is received within the housing assembly. The at least one accessory compartment assembly occupies at least a portion of the dead space. The accessory compartment assembly includes at least one accessory compartment separation element for providing a desired separation of the spectacle compartment and the accessory compartment assembly.

### CROSS-REFERENCE TO RELATED APPLICATION(S)

This application is a divisional of U.S. patent application Ser. No. 10/794,684 filed Mar. 5, 2004, titled “Multipurpose Spectacle Case,” the entirety of which is incorporated herein by reference.

### TECHNICAL FIELD

The present invention relates to spectacle (i.e. eyeglass) cases and more particularly to an eyeglass case having internal compartments for storing accessory items.

### BACKGROUND

A variety of types of cases for containing spectacles are known. Of these, certain dual-function eyeglass cases existing in the art may have some tangential general relevance to the present invention. Of interest are U.S. Pat. Nos. 683,417 to Weinstein, 1,004,474 to Schnorr, 1,649,255 to Robinson, and 3,000,417 to Goldstein, each of which teaches a case for containing two pairs of eyeglasses. Similarly, of general interest is U.S. Pat. No. 3,323,638 to Dishart which teaches an eyeglass case for containing a pair of spectacles, a nail file, a comb, a nail clipper, and a magnifying glass.

U.S. Pat. No. 6,003,663 to Newcomber discloses an eyeglass case generally comprising a substantially rigid internal shell member surrounded by a flexible covering material provided with a closure flap selectively securable in a closed position for retaining eyeglasses in protective storage within the inner shell member. The shell member includes an inverted V-shaped support member extending upwardly from a floor of the shell member which engages a nose recess of a pair of eyeglasses stored within the case. In accordance with embodiments of the invention, the shell member includes one or more internal receptacles for storage of miscellaneous accessory items such as nose pads, spare screws, a small screwdriver, lens cleaning solution, a lens wiping cloth, etc.

U.S. Pat. No. 5,016,749 to Kaye et al discloses an eyeglass and contact lens holder that includes a carrying case for simultaneously carrying spectacles and contact lenses. The case has a hollow open base for containing the spectacles and further contains a contact lens case secured to an interior surface of the base where contact lenses may be stored. A lid is hingedly connected to the base for covering the open portion thereof.

It is an object of the present invention to provide an improved eyeglass case.

### SUMMARY

In a broad aspect, the present invention is a spectacle case including a housing assembly, a spectacle compartment, and at least one accessory compartment assembly. The housing assembly defines a housing space for storing a pair of spectacles therein. The housing space comprises a spectacle space and a remaining dead space. The spectacle compartment occupies the spectacle space defining an area that is reserved for occupation of the spectacle when the spectacle is received within the housing assembly. The at least one accessory compartment assembly occupies at least a portion of the dead space. The accessory compartment assembly includes at least one accessory compartment separation element for providing a desired separation of the spectacle compartment and the accessory compartment assembly.

Various shapes and types of spectacle compartment and accessory compartment assemblies are disclosed. For example, the accessory compartment assemblies may include radios, thermometers, calculators, clocks, etc.

In the preferred embodiment, the housing space defines a dimension that minimally fits a pre-determined eyewear such that the housing space is only large enough to accommodate the eyewear as well as the dead space that is created by the irregular shape of a spectacle. As such, the eyewear case according to the present invention does not need to be larger than a standard eyewear case that a pair of spectacle can barely fit into, yet contains additional compartment(s) and/or function(s) not found in a prior art case of the same dimensions.

In another aspect of the present invention, a multi-purpose eyeglass case is provided with a radio assembly disposed within the housing of the case.

Use of the present invention has several advantages over prior art devices. These include space savings, convenience, multi-functionality.

### BRIEF DESCRIPTION OF THE DRAWINGS

FIG. 1A is a front, left perspective view of a first embodiment of the present invention illustrating the use of the accessory compartment assemblies for a clock and a thermometer.

FIG. 1B is a top, left perspective view of an upper portion of the FIG. 1A embodiment with the lid open to reveal the accessory compartment assembly.

FIG. 1C is an end view of the lid of the FIG. 1A embodiment.

FIG. 1D is a side view of an upper portion of the FIG. 1A embodiment.

FIG. 1E is a section of FIG. 1A showing a hidden integrated circuit board position.

FIG. 2A is a front, left perspective view of a second embodiment showing utilization of a clamshell assembly with a radio, with the spectacle case in a closed position.

FIG. 2B is a front, left perspective view of the FIG. 2A embodiment in an open position.

FIG. 2C is a section of FIG. 2A showing a hidden integrated circuit board position.

FIG. 3A is a perspective view of a third embodiment showing utilization of a clamshell assembly with a radio and arcuately spaced accessory compartments, with the spectacle case being in a closed position.

FIG. 3B is a perspective view of the FIG. 3A embodiment in an open position.

FIG. 4A is a perspective view of another embodiment showing utilization of a clamshell assembly with a radio attached to the cover, with the spectacle case being shown in a closed position.

FIG. 4B is a perspective view of the FIG. 4A embodiment in an open position.

FIG. 5A is a perspective view of another embodiment showing utilization of a clamshell assembly with a radio attached to an arching upper clamshell section, with the spectacle case being shown in a closed position.

FIG. 5B is a perspective view of the FIG. 5A embodiment in an open position.

FIG. 5C is a section of FIG. 5A showing a hidden integrated circuit board position.

FIG. 6A is a perspective view of another embodiment showing utilization of a clamshell assembly with a calculator assembly, with the spectacle case being shown in a closed position.

FIG. 6B is a perspective view of the FIG. 6A embodiment in an open position.

FIG. 6C is a bottom perspective view of an end portion of the FIG. 6A embodiment in an open position.

FIG. 6D is a section of FIG. 6A showing a hidden integrated circuit board position.

FIG. 7A is a perspective view of another embodiment showing utilization of a clamshell assembly having an oval cross-sectional area, with the spectacle case being shown in a closed position.

FIG. 7B is a perspective view of the FIG. 7A embodiment in an open position.

FIG. 7C is a section of FIG. 7B showing a hidden integrated circuit board position.

FIG. 7D is a section of FIG. 7B showing how an accessory compartment on the lid is opened.

FIG. 7E is a section of FIG. 7B showing how an accessory compartment located in the side of the case base is opened.

FIG. 8A is a perspective view of another embodiment showing utilization of a clamshell assembly having a radio and a plurality of arcuately spaced accessory compartments located about an internal surface of lower sidewalls of an arc-shaped base.

FIG. 8B is a perspective view of the FIG. 8A embodiment in an open position.

FIG. 9A is a perspective view of another embodiment showing utilization of a clamshell assembly with a detachable Radio assembly.

FIG. 9B is a perspective view of the FIG. 8A embodiment with the detachable Radio assembly shown detached therefrom.

FIG. 9C is a top perspective view of the detachable radio assembly of the FIG. 9A embodiment.

FIG. 9D is a bottom perspective view of the detachable radio assembly of the FIG. 9A embodiment, revealing the bracket for attachment.

FIG. 9E is a side view of the detachable radio assembly of the FIG. 9D embodiment.

FIG. 9F is a perspective view of the FIG. 9A embodiment in an open position, with the detachable radio assembly shown removed.

### DETAILED DESCRIPTION

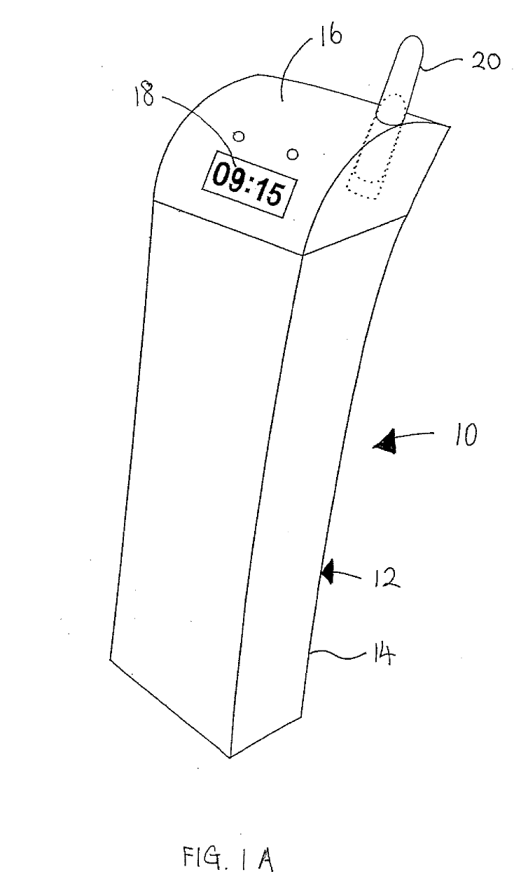

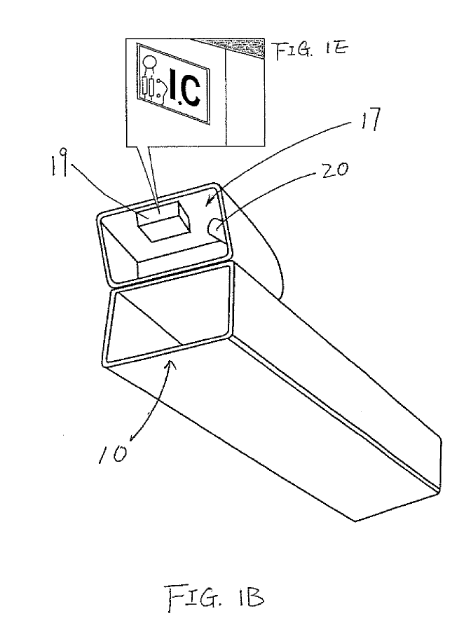

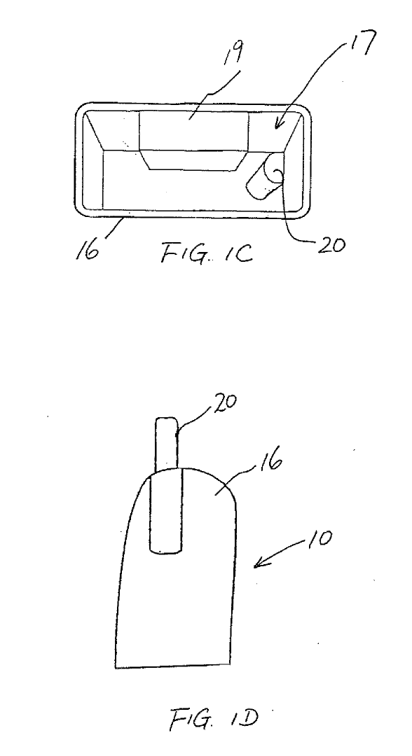

Referring now to the drawings and the characters of reference marked thereon, FIGS. 1A-1E illustrate a first preferred embodiment of the present invention, designated generally as 10. The spectacle case 10 includes a housing assembly, designated generally as 12, defining a housing space 17 for storing a pair of spectacles therein. The housing assembly 12, in this embodiment, is an elongated tubular container having a closed lower end 14 and a lid 16 hingedly attached to an upper end thereof. The lid 16 has least one accessory compartment assembly. In this instance, the lid 16 includes a digital display 18 (e.g., a digital display clock or temperature indicator) and a thermometer 20. A compartment 19 is included in the lid to protect an integrated circuit board. Thus, in terms of space utilization, the housing space 17 includes a spectacle space and a remaining dead space. A spectacle compartment occupies the spectacle space defining an area that is reserved for occupation of a spectacle when the spectacle is received within the housing assembly. The accessory compartments 19, 20 occupy a portion of the dead space of the housing space 17.

Although the digital display 18 and thermometer 20 are shown in this figure various other types of devices, such as radios, etc. could be used instead. In FIGS. 1A-1D the housing assembly 12 has a rectangular cross-section. However, it is understood that various other shapes may be fabricated as desired.

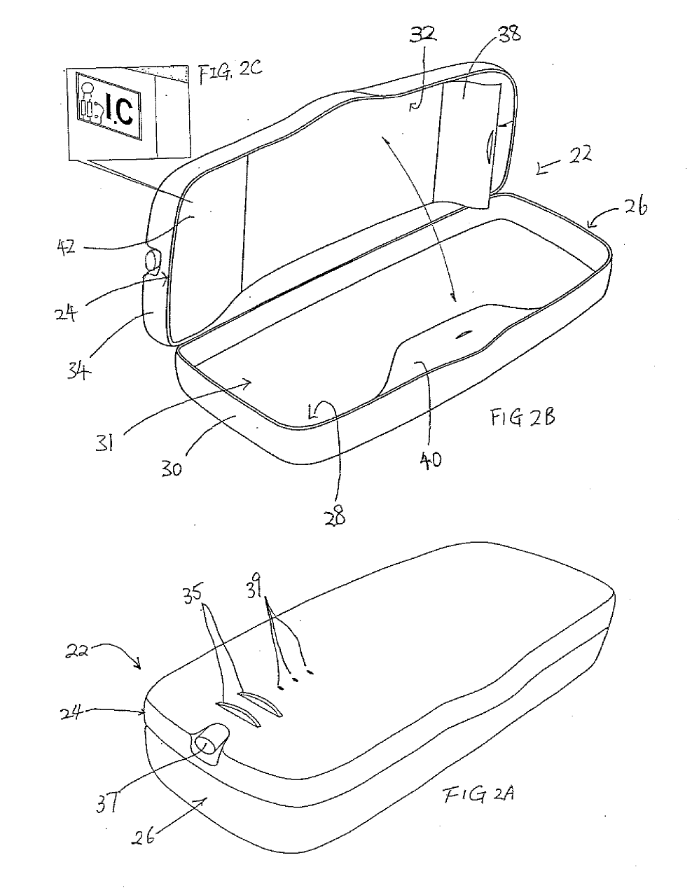

Referring now to FIGS. 2A-2C, a second embodiment of the present invention is illustrated, designated generally as 22. In this embodiment, the housing assembly comprises a clamshell assembly comprising an upper clamshell section 24 hingedly attached to a lower clamshell section 26. The housing assembly defines a housing space 31 for storing a pair of spectacles therein. The housing space 31 includes a spectacle space and a remaining dead space. The lower clamshell section 26 includes a base 28 and substantially perpendicular lower sidewalls 30 extending from the base 28. The upper clamshell section 24 comprises a ceiling 32 and substantially perpendicular upper sidewalls 34 extending from the ceiling 32.

An accessory compartment assembly includes a radio assembly having controls 35 (such as a volume switch and channel switch), an antenna 37, and indicator lights 39. An accessory compartment separation element 38 is operatively associated with the ceiling to separate the spectacle space from the dead space. The accessory compartment separation element 38 may comprise a flap, as shown in the figure, or other suitable separation elements such as a door or panel. Another accessory compartment may be a battery compartment 40 for the radio assembly which may be conveniently located in a volume formed within the lower clamshell section 26. Another accessory compartment 42 on the other end of the upper clamshell section 24 may be used to support the integrated circuit of the radio assembly or other small accessories as desired. The radio assembly and the compartments 40 and 42 occupy a portion of the dead space of the housing space 31.

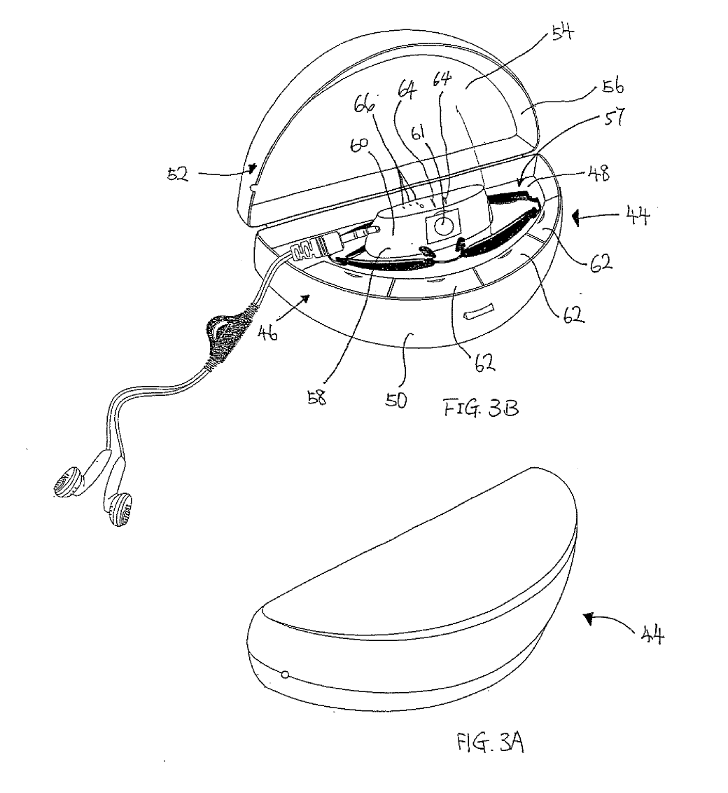

Referring now to FIGS. 3A and 3B, a third embodiment of the present invention is illustrated, designated generally as 44. The housing assembly defines a housing space 57 for storing a pair of spectacles therein. The housing space 57 includes a spectacle space and a remaining dead space. In this embodiment, a lower clamshell section, designated generally as 46 comprises an arc-shaped base 48 and substantially perpendicular lower sidewalls 50 extending from the base 48. An upper clamshell section, designated generally as 52, comprises a ceiling 54 and substantially perpendicular upper sidewalls 56 extending from the ceiling 54.

In this embodiment the accessory compartment assembly includes a radio assembly 58 utilizing an accessory compartment separation element 60 that is operatively associated with the base 48. A battery compartment 61 can be included in the accessory compartment separation element 60. The radio assembly 58 and the battery compartment 61 generally occupy a portion of the dead space of the housing space 57. A plurality of arcuately spaced accessory compartments 62 are located about an internal surface of the lower sidewalls 50 of the arc-shaped base 48 to occupy a portion of the dead space of the housing space 57. Appropriate switches 64 and indicator lights 66 may be provided on the top surfaces of the radio assembly 58.

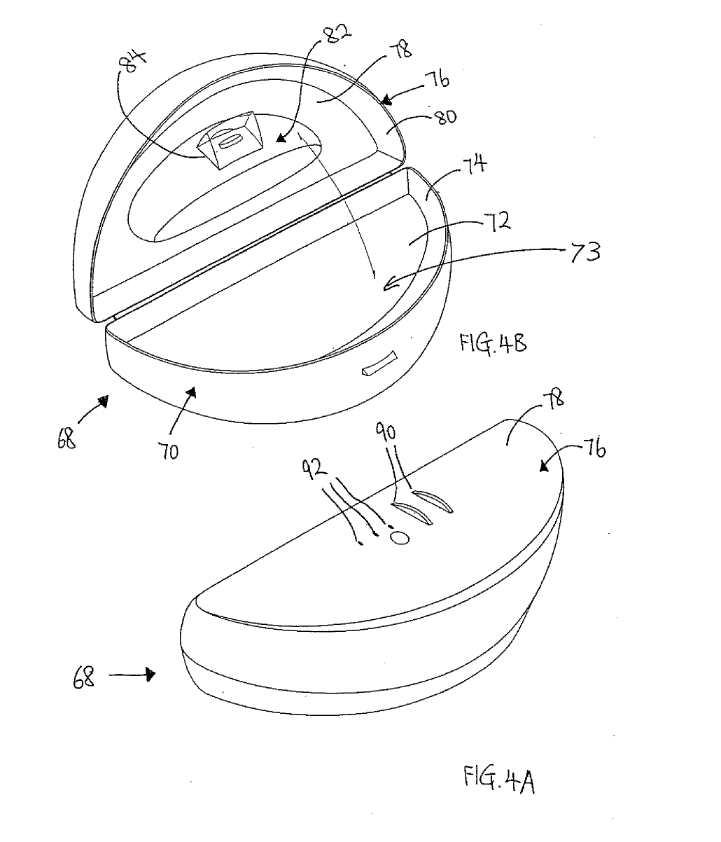

Referring now to FIGS. 4A and 4B, another embodiment of the present invention is illustrated, designated generally as 68. The housing assembly defines a housing space 73 for storing a pair of spectacles therein. The housing space 73 includes a spectacle space and a remaining dead space. As in the previous embodiment, a lower clamshell section, designated generally as 70 comprises an arc-shaped base 72 and substantially perpendicular lower sidewalls 74 extending from the base 72. An upper clamshell section, designated generally as 76, comprises a ceiling 78 and substantially perpendicular upper sidewalls 80 extending from the ceiling 78.

In this embodiment the accessory compartment assembly includes a radio assembly 82 utilizing an accessory compartment separation element 84 that is operatively associated with the ceiling 78 such that the radio assembly 82 is affixed to the ceiling 78. A battery compartment can be included in the accessory compartment separation element 84. The radio assembly 82 and the battery compartment occupy a portion of the dead space of the housing space 73. As shown in FIG. 4A, appropriate switches 90 and indicator lights 92 may be provided on the upper clamshell section 76.

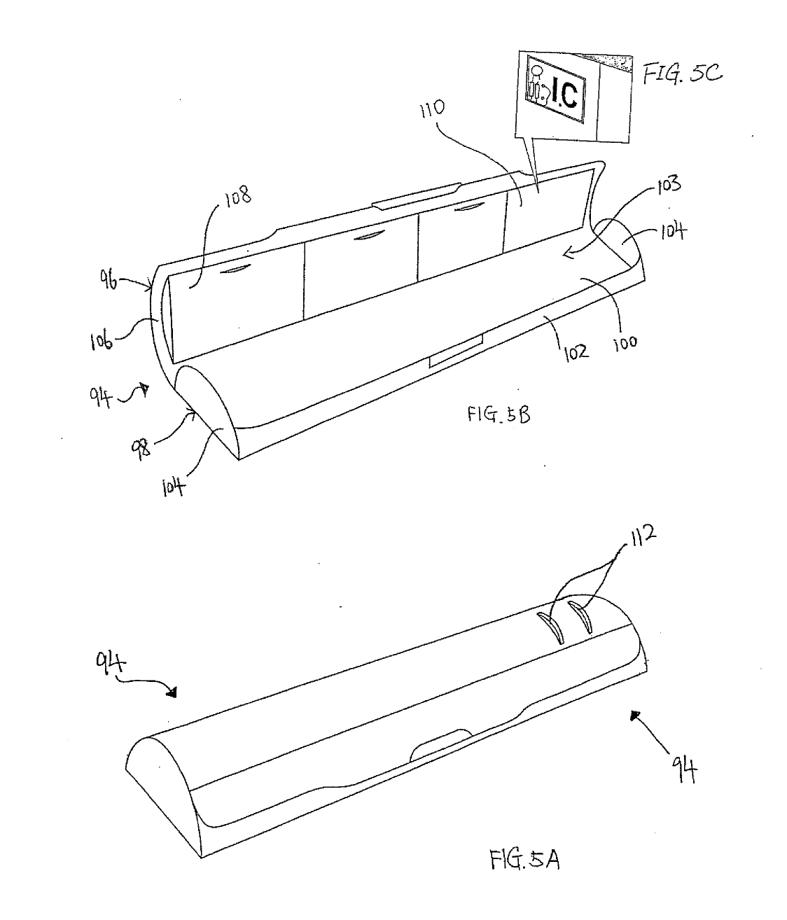

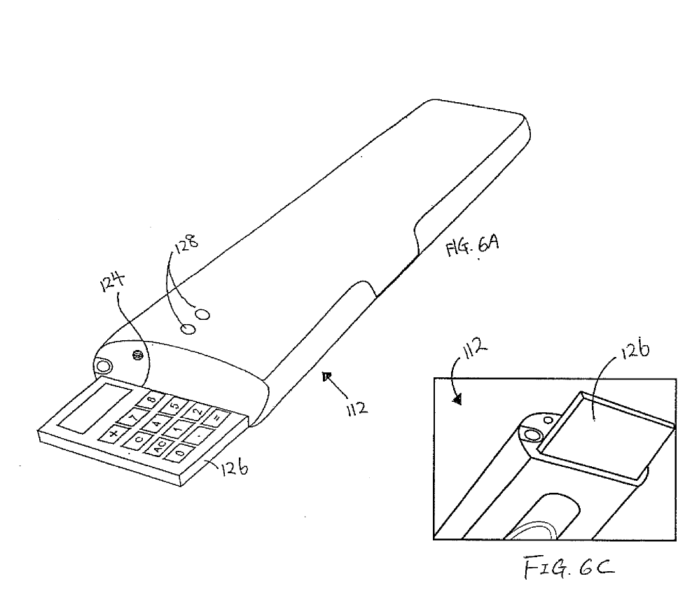

Referring now to FIGS. 5A-5C, another embodiment of the present invention is illustrated, designated generally as 94. The housing assembly defines a housing space 103 for storing a pair of spectacles therein. The housing space 103 includes a spectacle space and a remaining dead space. In this embodiment, the housing assembly comprises a clamshell assembly having an arching upper clamshell section 96 hingedly attached to a lower clamshell section 98. The lower clamshell section 98 comprises a base 100, a lower clamshell section front panel 102 extending upwardly from the base 100 and two arc shaped lower clamshell side panels 104 extending upwardly from the base 100. The arching upper clamshell section 96 includes two arc shaped upper clamshell side panels 106 being sized to cooperate with the two arc shaped lower clamshell side panels 104.

A series of spaced accessory compartments are formed by a plurality of accessory compartment separation elements 108. The accessory compartment separation elements 108 are each fixedly attached to a rear portion of the arching upper clamshell section so as to open at a front portion of the upper clamshell section 96. One of the spaced accessory compartments is a radio assembly 110 including it knobs 112 and headphone plug-in (not shown). The spaced accessory compartments occupy a portion of the dead space of the housing space 103. The base 100 may be substantially rectangular to particularly accommodate a pair of reading glasses.

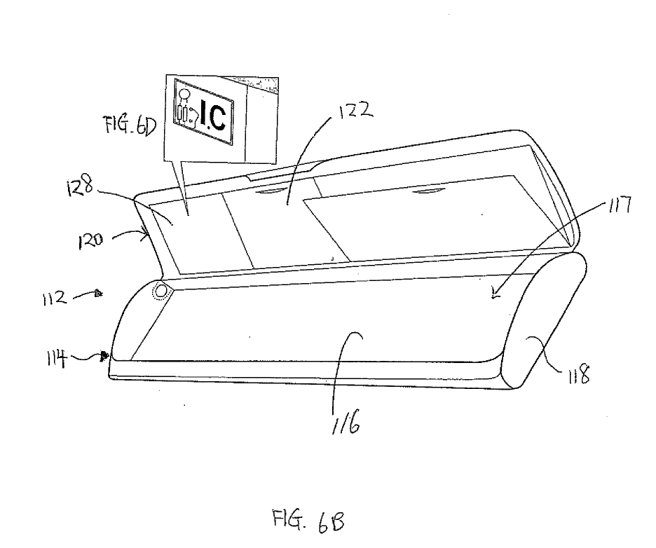

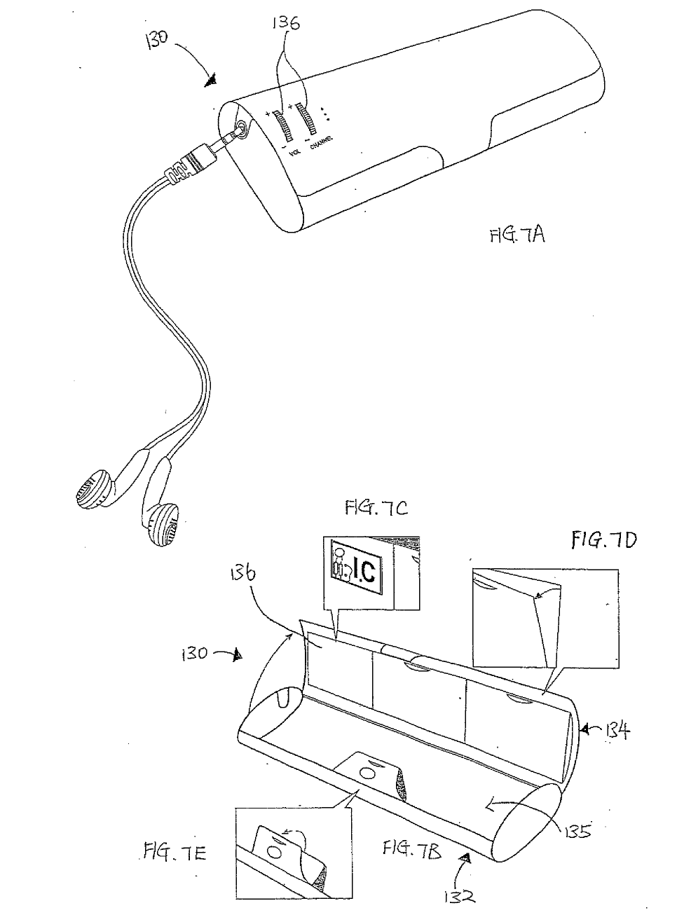

Referring now to FIGS. 6A-6D, another embodiment of the present invention is illustrated, designated generally as 112. The housing assembly defines a housing space 117 for storing a pair of spectacles therein. The housing space 117 includes a spectacle space and a remaining dead space. In this embodiment, a lower clamshell section 114 comprises a base 116 and substantially perpendicular lower sidewalls 118 extending from the base 116.

An upper clamshell section 120 comprises a ceiling 122 which operatively associates with the lower clamshell section 114 to provide a closed structure when the housing assembly is closed. The accessory compartment assembly includes a calculator assembly having a calculator opening 124 provided in one of the clamshell sections and a calculator 126 being sized for convenient storage within the calculator opening 124. It also includes a radio assembly 128 affixed to the ceiling 122. The accessory compartment assembly occupies a portion of the dead space of the housing space 117.

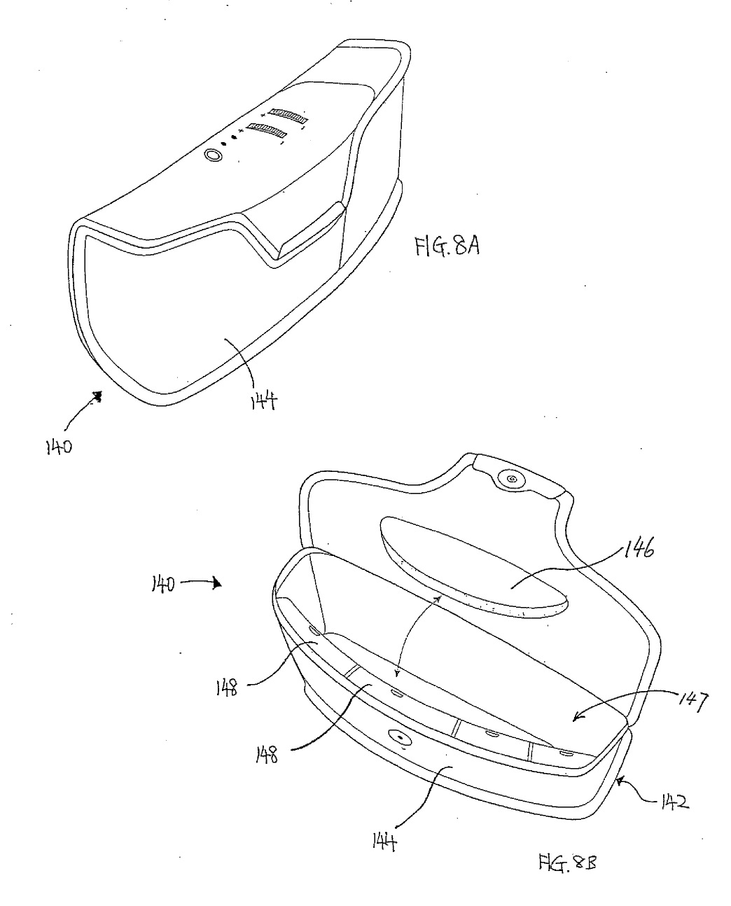

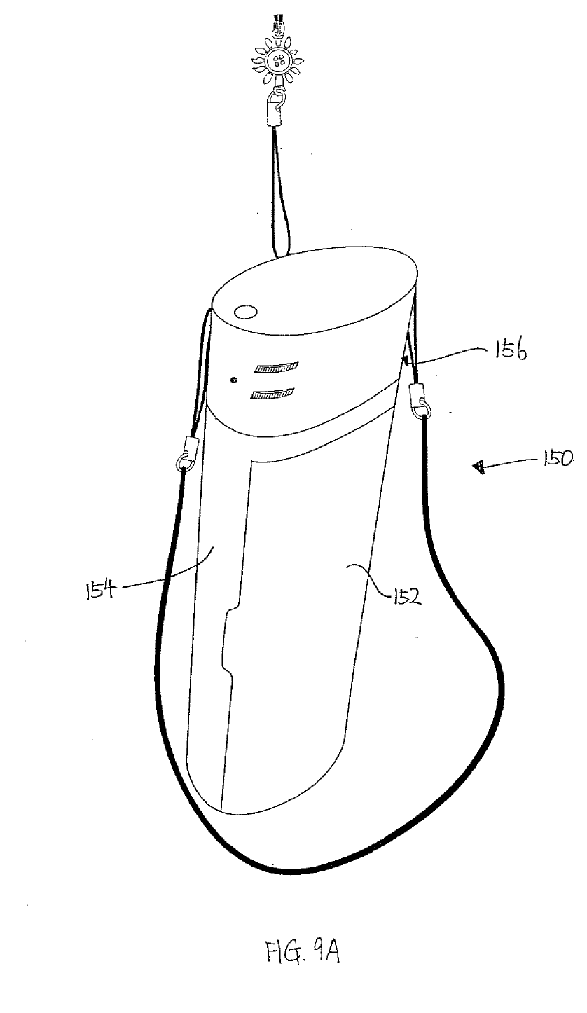

Referring now to FIGS. 7A-7E, another embodiment is illustrated, designated generally as 130. The housing assembly defines a housing space 135 for storing a pair of spectacles therein. The housing space 135 includes a spectacle space and a remaining dead space. In this embodiment, a lower clamshell section 132 and upper clamshell section 134 cooperate to provide a clamshell assembly having an oval cross-sectional area. A radio assembly 136 is operatively associated with the ceiling of the upper clamshell section 134 so as to affix the radio assembly 136 to the ceiling. FIG. 7C schematically illustrates the positioning of an integrated circuit in one of the accessory compartments. FIG. 7D is a section of FIG. 7B showing how an accessory compartment on the lid is opened. FIG. 7E is a section of FIG. 7B showing how another accessory compartment located in the side of the case base is opened. The radio assembly 136 and the accessory compartments occupy a portion of the dead space of the housing space 135.

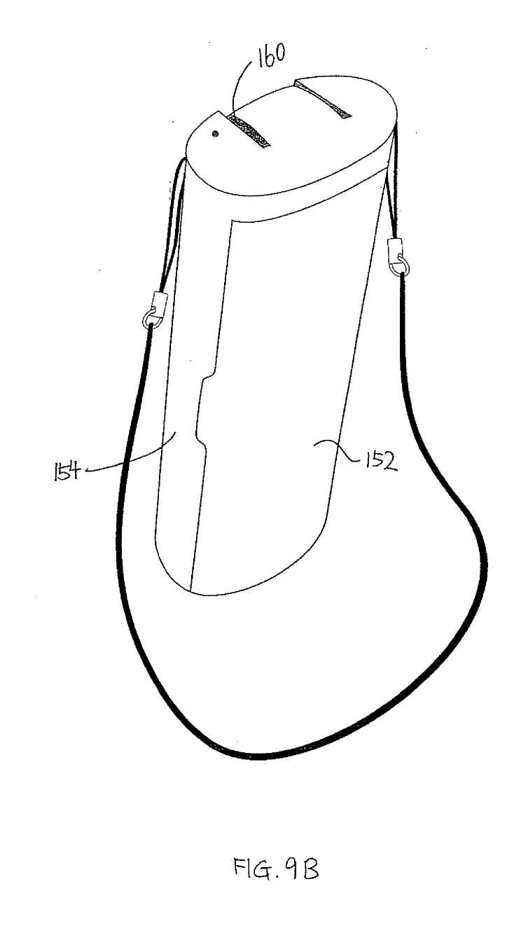

Referring now to FIGS. 8A and 8B, another embodiment of the present invention is illustrated, designated generally as 140. The housing assembly defines a housing space 147 for storing a pair of spectacles therein. The housing space 147 includes a spectacle space and a remaining dead space. In this embodiment, the lower clamshell section 142 comprises an arc-shaped base and substantially perpendicular lower sidewalls 144 extending from the base. This embodiment includes a radio assembly 146 operatively associated with the ceiling. In the illustrated embodiment, the radio assembly 146 has a disc shape. The radio assembly 146 may include a battery compartment. The radio assembly 146 generally occupies a portion of the dead space of the housing space 147 of the spectacle case 140. A plurality of arcuately spaced accessory compartments 148 are located about an internal surface of the lower sidewalls 144 of the arc-shaped base. The accessory compartments 148 generally occupy a portion of the dead space of the housing space 147 of the spectacle case 140.

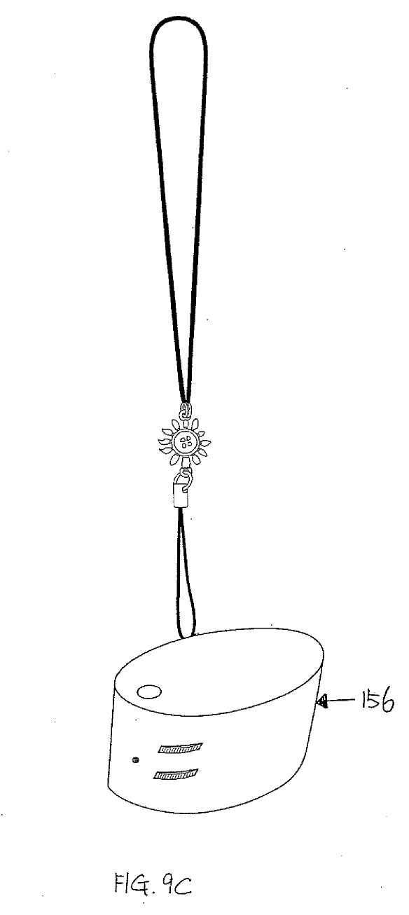

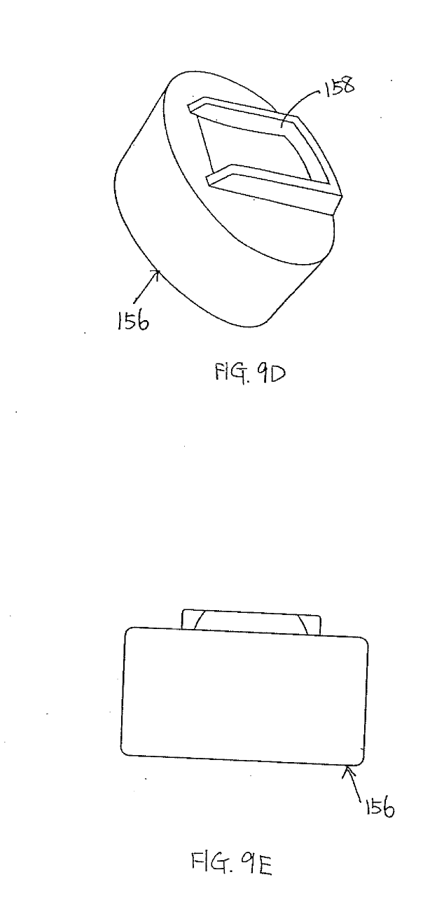

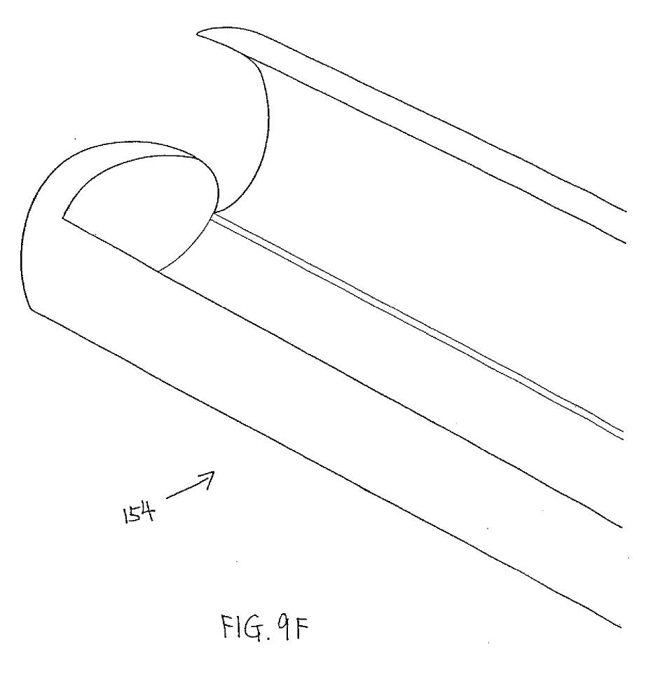

Referring now to FIGS. 9A-9F, another embodiment is illustrated, designated generally as 150. In this embodiment, the housing assembly includes a clamshell assembly comprising an upper clamshell section 152 hingedly attached to a lower clamshell section 154. The lower clamshell section comprises a base and sidewalls extending from the base. In the embodiment shown the base and sidewalls are contiguous so that there is approximately an oval cross-section. The upper clamshell section 152 comprises a ceiling which operatively associates with the lower clamshell section 154 to provide a closed structure when the housing assembly is closed.

A detachable accessory compartment assembly, such as a radio assembly, designated generally as 156, may be removed from the clamshell assembly. Although various fastening mechanisms can be utilized these Figures show use of a slideable bracket 158 and slot 160. The removable attachment configuration provides advantages. For example, the user can carry either the clamshell assembly or the radio assembly. The user can also carry the combination of the clamshell assembly and the radio assembly when needed.

Although specific embodiments have been described above the inventive principles herein can be used to provide numerous combinations of accessories and compartments, such as a combination spectacle case/radio, combination spectacle case/thermometer, combination spectacle case/calculator, etc.

Other embodiments and configurations may be devised without departing from the spirit of the invention and the scope of the appended claims.

What is claimed is:

1. A spectacle case, comprising:
a housing assembly defining a housing space for storing a pair of spectacles therein, said housing space comprising a spectacle space and a remaining dead space;
a spectacle compartment occupying said spectacle space defining an area that is reserved for occupation of said spectacle when said spectacle is received within said housing assembly;
at least one accessory compartment assembly occupying at least a portion of said dead space, said at least one accessory compartment assembly including at least one accessory compartment separation element for providing a desired separation of said spectacle compartment and said at least one accessory compartment assembly;
a clamshell assembly being said housing assembly, said clamshell assembly comprising an upper clamshell section hingedly attached to a lower clamshell section, said lower clamshell section comprising a base and sidewalls extending from said base, said upper clamshell section comprising a ceiling operatively connected to said lower clamshell section to provide a closed structure when the housing assembly is closed; and
a detachable accessory compartment assembly being said at least one accessory compartment assembly, said detachable accessory compartment assembly being detachable from an end of said clamshell assembly.

2. The spectacle case according to claim 1, wherein said at least one accessory compartment assembly comprises an electronic device assembly, and said at least one accessory compartment separation element is operatively connected to said ceiling.

3. The spectacle case according to claim 2, wherein the electronic device assembly is selected from the group consisting of: radio, thermometer, calculator, and clock.

4. The spectacle case according to claim 1, wherein said at least one accessory compartment assembly comprises an electronic device assembly, and said at least one accessory compartment separation element is operatively connected to said ceiling to separate said spectacle space from said remaining dead space, said at least one accessory compartment separation element comprising a flap.

5. The spectacle case according to claim 4, wherein the electronic device assembly is selected from the group consisting of: radio, thermometer, calculator, and clock.

6. The spectacle case according to claim 1, wherein said at least one accessory compartment assembly comprises:
an electronic device assembly, and said at least one accessory compartment separation element is operatively connected to said ceiling to separate said spectacle space from said remaining dead space, said at least one accessory compartment separation element comprising a flap; and
a battery compartment located in a volume formed within said lower clamshell section.

7. The spectacle case according to claim 6, wherein the electronic device assembly is selected from the group consisting of: radio, thermometer, calculator, and clock.

8. The spectacle case according to claim 1, wherein said at least one accessory compartment assembly, comprises:
an electronic device assembly, said at least one accessory compartment separation element is operatively connected to said ceiling to separate said spectacle space from said remaining dead space, said at least one accessory compartment separation element comprising a flap; and
a battery compartment located in a volume formed within said lower clamshell section wherein an upper surface of said upper clamshell section includes a desired volume switch, channel switch, on/off switch, indicator light and an antenna.

9. The spectacle case according to claim 8, wherein the electronic device assembly is selected from the group consisting of: radio, thermometer, calculator, and clock.

10. The spectacle case according to claim 1, wherein said at least one accessory compartment assembly, comprises an electronic device assembly, said at least one accessory compartment separation element is operatively connected to said ceiling so as to affix said electronic device assembly to said ceiling.

11. The spectacle case according to claim 10, wherein the electronic device assembly is selected from the group consisting of: radio, thermometer, calculator, and clock.

12. The spectacle case according to claim 1, wherein said detachable accessory compartment assembly includes a bracket assembly.

13. The spectacle case according to claim 1, wherein said detachable accessory compartment assembly comprises a radio assembly.

14. A combination spectacle case/radio, comprising:
a housing assembly defining a housing space for storing a pair of spectacles therein, said housing space comprising a spectacle space and a remaining dead space;
a spectacle compartment occupying said spectacle space defining an area that is reserved for occupation of said spectacle when said spectacle is received within said housing assembly; and
a radio assembly occupying at least a portion of said dead space, said at least one radio assembly including a radio assembly separation element for providing a desired separation of said spectacle compartment and said radio assembly.

15. A combination spectacle case/thermometer, comprising:
a housing assembly defining a housing space for storing a pair of spectacles therein, said housing space comprising a spectacle space and a remaining dead space;
a spectacle compartment occupying said spectacle space defining an area that is reserved for occupation of said spectacle when said spectacle is received within said housing assembly; and
a thermometer assembly occupying at least a portion of said dead space, said at least one thermometer assembly including a thermometer assembly separation element for providing a desired separation of said spectacle compartment and said thermometer assembly.

16. A combination spectacle case/calculator, comprising:
a housing assembly defining a housing space for storing a pair of spectacles therein, said housing space comprising a spectacle space and a remaining dead space;
a spectacle compartment occupying said spectacle space defining an area that is reserved for occupation of said spectacle when said spectacle is received within said housing assembly; and
a calculator assembly occupying at least a portion of said dead space, said at least one calculator assembly including a calculator assembly separation element for providing a desired separation of said spectacle compartment and said calculator assembly.
